(19) United States
(12) Patent Application Publication
(10) Pub. No.: US 2015/0287138 A1
(43) Pub. Date: Oct. 8, 2015

(54) EXTENDING TEMPORARY CREDIT BASED ON RISK FACTORS

(71) Applicant: EBAY INC., San Jose, CA (US)

(72) Inventor: John Hastings Granbery, Los Altos, CA (US)

(21) Appl. No.: 14/248,241

(22) Filed: Apr. 8, 2014

(51) Int. Cl. G06Q 40/02

(52) U.S. Cl. CPC G06Q 40/025

(57) ABSTRACT

Systems and methods are provided for extending short term credit to a user when a user enters a location or checks in to a location. The credit may be extended based on a risk score determined based on risk factors associated with the user. The risk factors used to determine the risk score may include a purchase history, a payment history, past amounts paid, a first number of credit cards associated with the user, and past credit extended to the user. Credit information from a credit server may also be used to determine the risk score. The determined risk score may be compared to one or more thresholds to determine if credit should be extended to the user and, if credit is to be extended, the amount of credit to be extended.

### BACKGROUND

1. Technical Field

Embodiments disclosed herein are related to extending temporary credit to a user at a location based on a risk score determined from risk factors associated with the user.

2. Related Art

The increased use of the internet and internet capable devices has led to the increased use of online payment processors due to the convenience that these processors provide. Online payment processors may provide consumers with the ability to purchase items with minimal effort from their internet capable device, with the payments being handled through a consumer's credit or checking account, or through a financial account that the consumer has set up with the payment processor. Online payment processors may be able to extend credit to a user based on a risk associated with extending credit to the user. While information about such a risk may be available from credit monitoring agencies, that information may cost money and take time to retrieve.

### BRIEF DESCRIPTION OF THE FIGURES

FIG. 1 is a block diagram of a networked system, consistent with some embodiments.

FIG. 2 is a diagram illustrating a computing system, consistent with some embodiments.

FIG. 3 is a diagram illustrating risk factors used to determine a risk score, consistent with some embodiments.

FIG. 4 is a flowchart illustrating a process for evaluating a credit request, consistent with some embodiments.

FIG. 5 is a flowchart illustrating a process for evaluating a credit request, consistent with some embodiments.

In the drawings, elements having the same designation have the same or similar functions.

### DETAILED DESCRIPTION

In the following description specific details are set forth describing certain embodiments. It will be apparent, however, to one skilled in the art that the disclosed embodiments may be practiced without some or all of these specific details. The specific embodiments presented are meant to be illustrative, but not limiting. One skilled in the art may realize other material that, although not specifically described herein, is within the scope and spirit of this disclosure.

What is needed are systems and methods for extending credit to a user based on risk factors associated with the user and based on information about the user that is already available to the entity extending credit. Moreover, systems and methods are needed for providing time limited credit to a user to use at a location based on the risk factors.

Consistent with some embodiments, there is provided a system for determining a risk in extending credit to a user. The system includes one or more processors configured to receive an indication that a user is at a location, receive risk factors from account information of the user, the risk factors including at least a purchase history, a payment history, past amounts paid, a first number of credit cards associated with the user, and past credit extended to the user, and determine a risk score based on the received risk factors. The one or more processors are further configured to determine when the risk score is greater than a threshold, and extend credit to the user when the risk score is greater than the threshold. The system also includes a memory coupled to the one or more processors and configured to store the account information of the user including the risk factors.

Consistent with some embodiments, there is also provided a method for extending credit to a user. The method includes steps of receiving an indication that a user is at a location, receiving risk factors from account information of the user, the risk factors including at least a purchase history, a payment history, past amounts paid, a first number of credit cards associated with the user, and past credit extended to the user, and determining a risk score based on the received risk factors, determining when the risk score is greater than a threshold, and extending credit to the user when the risk score is greater than the threshold. The method may also be embodied in computer-readable media.

Consistent with some embodiments, there is further provided a method for extending credit to a user. The method includes steps of receiving a request to check the user into a location, receiving risk factors from account information of the user associated with the payment processing server stored in a memory of the payment processing server, the risk factors including at least a purchase history, a payment history, past amounts paid, a first number of credit cards associated with the user, and past credit extended to the user, and determining a risk score based on the received risk factors. The method further includes steps of determining when the risk score is greater than a threshold, extending an initial amount of credit to the user when the risk score is greater than the threshold, the credit being specific to the location and having an expiration time, determining when the user authenticates with the payment processing server, and extending a second amount of credit to the user that is larger than the initial amount of credit when the user authenticates with the payment processing server. The method may also be embodied in computer-readable media.

Embodiments as described herein may allow credit to be extended to a user based on a risk score determined from risk factors associated with the user. Moreover, embodiments as described herein may also allow a user to obtain time limited and location limited credit to allow the user to use credit to purchase one or more items at a locations.

These and other embodiments will be described in further detail below with respect to the following figures.

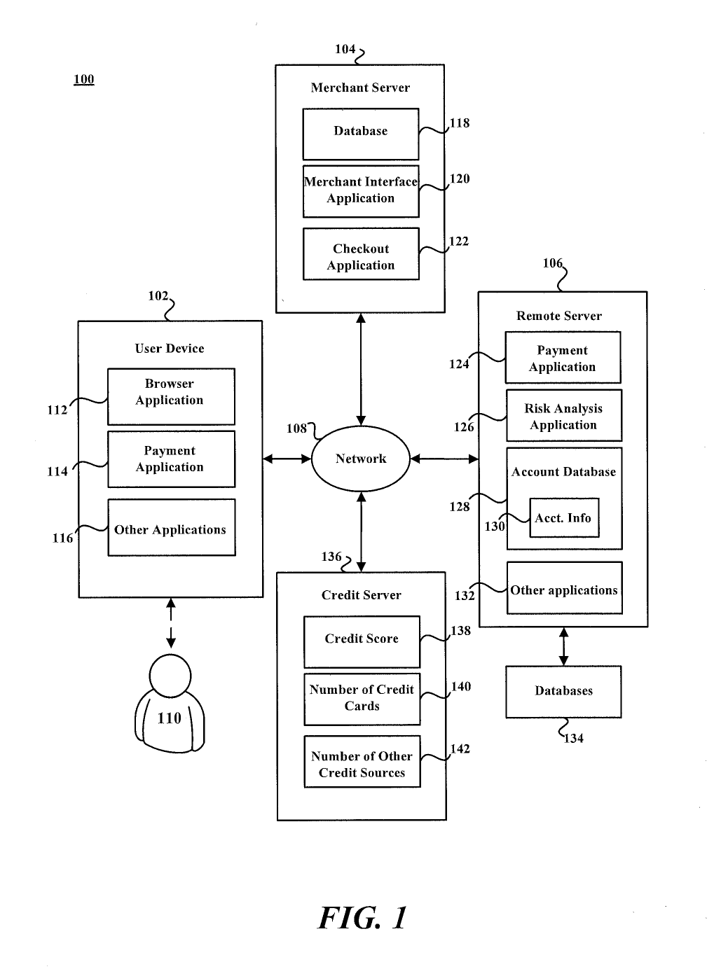

FIG. 1 is a block diagram of a networked system 100, consistent with some embodiments. System 100 includes a user device 102, a merchant server 104, and a remote server 106 in communication over a network 108. User 110 may be communicating with merchant server 104 and/or remote server 106 over network 108 using user device 102. Remote server 106 may be a payment service processor or provider server that may be maintained by a payment processor or provider, such as PayPal, Inc. of San Jose, Calif. Remote server 106 may be maintained by other service providers in different embodiments.

Network 108, in one embodiment, may be implemented as a single network or a combination of multiple networks. For example, in various embodiments, network 108 may include the Internet and/or one or more intranets, landline networks, wireless networks, and/or other appropriate types of communication networks. In another example, the network may comprise a wireless telecommunications network (e.g., cellular phone network) adapted to communicate with other communication networks, such as the Internet.

User device 102 may be a mobile device such as a smartphone, a tablet computer, a laptop or netbook, and the like. User device 102 may also be a personal computer, a set-top box (STB) such as provided by cable or satellite content providers, a video game system console, or a smart or internet-enabled television. User device 102 may also be a head-mounted display (HMD) or other wearable computing device. User device 102 may be implemented using any appropriate combination of hardware and/or software configured for wired and/or wireless communication over network 108. Consistent with some embodiments, user device 102 may include any appropriate combination of hardware and/or software having one or more processors and capable of reading instructions stored on a non-transitory machine-readable medium for execution by the one or more processors. Consistent with some embodiments, user device 102 includes a machine-readable medium, such as a memory (not shown) that includes instructions for execution by one or more processors (not shown) for causing user device 102 to perform specific tasks. Some common forms of machine-readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which one or more processors or computer is adapted to read. Instructions stored on the machine-readable media may include instructions for authenticating user device 102 to remote server 106 to access services provided by remote server 106 and/or conducting financial transactions with remote server 106 for purchasing items offered by merchant server 104.

Such instructions may include instructions for displaying content by particular applications or “apps” stored in a memory of user device 102 and executed by one or more processors executing in user device 102. Example applications include a browser application 112 that displays content, such as a web page or a user interface using a browser, a payment application 114 that may be used to make payments in conjunction with remote server 106 for goods and/or services (referred to collectively as “items”). The items may be purchased from a merchant having a physical storefront or a digital storefront that is represented by merchant server 104. Browser application 112 may be implemented as a web browser to view information available over network 108. Browser application 112 may include instructions executable by one or more processors for interfacing and communicating with remote server 106, a merchant interface provided by merchant server 104, or other servers managed by content providers or merchants via network 108. For example, user 110 may be able to access websites using browser 112 to find and purchase items from merchant server 104 through a payment service provider provided by remote server 106, such as PayPal, as well as access user account information or web content. In some embodiments, user 110 may be able to use payment application 114 to pay for items, with the payments being processed by remote server 106. In some embodiments, payment application 114 may be able to interact with merchant server 104 and/or remoter server 106 to request credit for a specific amount or to cover a purchase being made from merchant server 104.

Other applications 116 may be desired in one or more embodiments to provide additional features available to user 110, including accessing a user account with remote server 106. For example, other applications 116 may include interfaces and/or communication protocols that allow the user to receive and transmit information through network 108 and to remote server 106 and other online sites. Other applications 116 may also include security applications for implementing client-side security features, programmatic client applications for interfacing with appropriate application programming interfaces (APIs) over network 108 or various other types of generally known programs and/or applications. Other applications 116 may include mobile apps downloaded and resident on user device 102 that enable user 110 to access content through the apps. Further, in some embodiments one or more of browser 112, payment application 114, or other applications 116 may be capable of enabling user 110 to check in to a location. In some embodiments, checking in to a location while visiting a location such as a merchant physical storefront may provide user with exclusive deals, offers, or may allow user to purchase and pay for items. The check-ins may be made automatically using wireless features of user device 102, such as Near Field Communications (NFC), Bluetooth®, or Bluetooth® Low Energy (BLE) wireless features.

Merchant server 104 may be maintained, for example, by a merchant or seller offering various items in exchange for payment to be received over network 108. In some embodiments, merchant server 104 may be in communication with a point of sale (POS) device maintained by the merchant in a physical storefront. Merchant server 104 may also include a database 118 identifying available items which may be made available for viewing and purchase by user 110. Database 118 may include descriptions, images, and pricing of the items. Merchant server 104 may also include a merchant interface application 120 which may be configured to serve information over network 108 to browser application 112 and/or payment application 114 of user device 102. In some embodiments, user 110 may interact with merchant interface application 120 through browser application 112 over network 108 in order to view various products, food items, or services identified in database 118.

Merchant server 104 also includes a checkout application 122 which may be configured to facilitate the purchase by user 110 of goods or services identified by merchant interface application 120. Checkout application 122 may be configured to accept payment information from or on behalf of user 110 through remote server 106 over network 108. For example, checkout application 122 may receive and process a payment confirmation from remote server 106, as well as transmit transaction information to remote server 106 and receive information from remote server 106. Checkout application 122 may also be configured to accept one or more different funding sources for payment including payments processed by remote server 104.

Remote server 106, according to some embodiments, may be maintained by an online payment provider, such as PayPal, Inc. of San Jose, Calif., which may provide processing for online financial and information transactions on behalf of user 110. In some embodiments, remote server 106 may also be capable of entering into credit agreements with user 110 to extend an amount of credit to user 110 for purchasing items, including items from merchant server 104. Remote server 106 may include payment application 124, which may be adapted to interact with user device 102 and merchant server 104 to process payments to be made by remote server 106 for items purchased by user 110 using user device 102, including items purchased from merchant server. Remote server 106, according to some embodiments, may also be capable of processing check ins so that a proprietor of a location, such as a merchant, or others know that user 110 is at the location or is able to provide user 110 with the ability to pay for goods using user device 102, receive offers, receive loyalty points, and the like.

Remote server 106 may also include a risk analysis application 126. In some embodiments, risk analysis application 126 may be capable of calculating a risk score based on credit and purchase information about user 110 which may be used to determine if credit should be extended to user 110 and if credit is to be extended, the amount of credit that may be extended to user 110. In some embodiments, the information that risk analysis application 126 may use to calculate a risk score may include a purchase history of user 110, a payment history of user 110, past amounts paid by user 110 that were processed by remote server 106, the number of different funding sources, such as credit cards, that user 110 has associated with their account, and any information about past credit that has been extended by remote server 106 to user 110. This information that is used by risk analysis application 126 may be stored locally in account database 128 and, in some embodiments, may also be received by third parties.

Account database 128 may include one or more databases, each of which may include account information 130 associated with individual users. For example, account information 130 may include private financial information of users of remote server 106 such as account numbers, credentials, passwords, device identifiers, user names, phone numbers, credit card information, bank information, or other financial information which may be used to facilitate online transactions by user 110. Account information 130 may also include purchase history of user 110, a payment history of user 110, past amounts paid by user 110 that were processed by remote server 106, the number of different funding sources, such as credit cards, that user 110 has associated with their account, and any information about past credit that has been extended by remote server 106 to user 110. Remote server 106 may also include other applications 132 and one or more additional databases 134 that may store additional information for use by remote server 106.

In some embodiments, system 100 may also include a credit server 136. Credit server 136 may be maintained by a credit card provider, a bank or other financial institution, or a credit monitoring company or agency. In some embodiments, merchant server 104 and/or remote server 106 may send requests to credit server 136 to obtain additional credit information about user 110. For example, credit server 136 may provide additional credit information related to a credit score 138 of user 110, a number of credit cards 140 that user 110 may have active, and a number of other sources of credit 142 (loans, mortgages, and the like) that are currently being extended to user 110. While merchant server 104 may have information about user 110 in database 118 that includes the credit cards or other credit information related to a user's past purchases at merchant, merchant server 104 may not have sufficient information to determine whether there is a risk in extending credit to user 110 and, thus, may obtain additional information from credit server 136 Similarly, remote server 106 may have credit information in account information 130 of account database 128 of user that may include financial institution information, credit card information, and the like, remote server 106 may need additional credit information from credit server 136 to determine if credit should be extended to user 110.

In some embodiments, remote server 106 may have very little or no credit information about user 110 and may be required to query credit server 136 for credit information. For example, remote server 106 may be a payment service processing server that processes payments for user 110 and user 110 may have an account with remote server 106 that is funded by cash only that is deposited at an Automated Teller Machine (ATM) or kiosk that is associated with user's 110 remote server 106 account. Consequently, remote server 104 may not have processed payments on behalf of user 110 that involved a financial institution or credit card. Thus, remote server 106 may need to query credit server 136 for additional credit information.

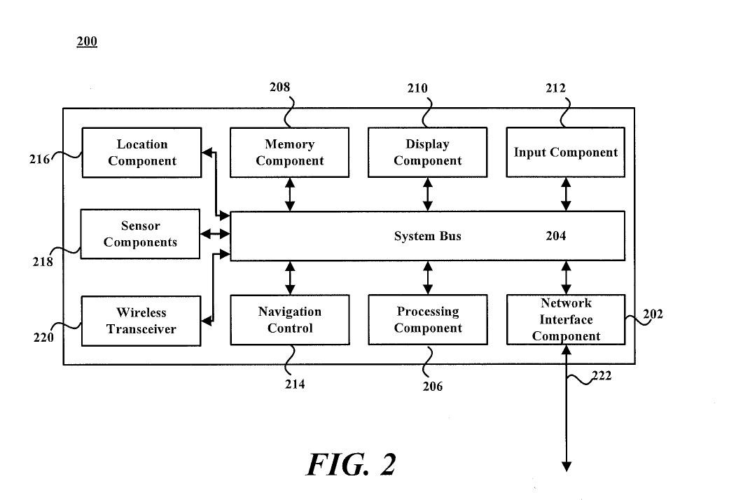

FIG. 2 is a diagram illustrating computing system 200, which may correspond to any of user device 102, merchant server 104, remote server 106, or credit server 136 consistent with some embodiments. Computing system 200 may be a mobile device such as a smartphone, a tablet computer, a personal computer, laptop computer, netbook, or tablet computer, set-top box, video game console, head-mounted display (HMD) or other wearable computing device as may be consistent with user device 102. Further, computing system 200 may also be a server or one server amongst a plurality of servers, as would be consistent with merchant server 104, remote server 106, and credit server 136. As shown in FIG. 2, computing system 200 includes a network interface component (NIC) 202 configured for communication with a network such as network 108 shown in FIG. 1. Consistent with some embodiments, NIC 202 includes a wireless communication component, such as a wireless broadband component, a wireless satellite component, or various other types of wireless communication components including radio frequency (RF), microwave frequency (MWF), and/or infrared (IR) components configured for communication with network 108. Consistent with other embodiments, NIC 202 may be configured to interface with a coaxial cable, a fiber optic cable, a digital subscriber line (DSL) modem, a public switched telephone network (PSTN) modem, an Ethernet device, and/or various other types of wired and/or wireless network communication devices adapted for communication with network 108.

Consistent with some embodiments, computing system 200 includes a system bus 204 for interconnecting various components within computing system 200 and communicating information between the various components. Such components include a processing component 206, which may be one or more processors, micro-controllers, graphics processing units (GPUs) or digital signal processors (DSPs), and a memory component 208, which may correspond to a random access memory (RAM), an internal memory component, a read-only memory (ROM), or an external or static optical, magnetic, or solid-state memory. Consistent with some embodiments, computing system 200 further includes a display component 210 for displaying information to a user 110 of computing system 200. Display component 210 may be a liquid crystal display (LCD) screen, an organic light emitting diode (OLED) screen (including active matrix AMOLED screens), an LED screen, a plasma display, or a cathode ray tube (CRT) display. Computing system 200 may also include an input component 212, allowing for a user of computing system 200, such as user 110, to input information to computing system 200. Such information could include payment information such as an amount required to complete a transaction, account information, authentication information such as a credential, or identification information. An input component 212 may include, for example, a keyboard or key pad, whether physical or virtual. Computing system 200 may further include a navigation control component 214, configured to allow a user to navigate along display component 210. Consistent with some embodiments, navigation control component 214 may be a mouse, a trackball, or other such device. Moreover, if system 200 includes a touch screen, display component 210, input component 212, and navigation control 214 may be a single integrated component, such as a capacitive sensor-based touch screen.

Computing system 200 may further include a location component 216 for determining a location of computing system 200. In some embodiments, location component 216 may correspond to a GPS transceiver that is in communication with one or more GPS satellites. In other embodiments, location component 216 may be configured to determine a location of computing system 200 by using an Internet protocol (IP) address lookup, or by triangulating a position based on nearby telecommunications towers or wireless access points (WAPs). Location component 216 may be further configured to store a user-defined location in memory component 208 that can be transmitted to a third party for the purpose of identifying a location of computing system 200. Computing system 200 may also include sensor components 218. Sensor components 218 provide sensor functionality, and may correspond to sensors built into user device 102 or sensor peripherals coupled to user device 102. Sensor components 218 may include any sensory device that captures information related to user 110 and/or user device 102 that may be associated with any actions that user 110 performs using user device 102. Sensor components 218 may include camera and imaging components, accelerometers, biometric readers, GPS devices, motion capture devices, and other devices that are capable of providing information about user device 102 or user 110, or an environment therearound. Computing system 200 may also include one or more wireless transceivers 220 that may each include an antenna that is separable or integral and is capable of transmitting and receiving information according to one or more wireless network protocols, such as Wi-Fi™, 3G, 4G, HSDPA, LTE, RF, NFC, IEEE 802.11a, b, g, n, ac, or ad, Bluetooth®, BLE, WiMAX, ZigBee®, etc.

Computing system 200 may perform specific operations by processing component 206 executing one or more sequences of instructions contained memory component 208. In other embodiments, hard-wired circuitry may be used in place of or in combination with software instructions to implement the present disclosure. Logic may be encoded in a computer readable medium, which may refer to any medium that participates in providing instructions to processing component 206 for execution, including memory component 208. Consistent with some embodiments, the computer readable medium is tangible and non-transitory. In various implementations, non-volatile media include optical or magnetic disks, volatile media includes dynamic memory, and transmission media includes coaxial cables, copper wire, and fiber optics, including wires that comprise system bus 204. Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computing system 200. In various other embodiments of the present disclosure, a plurality of computing systems 200 coupled by a communication link 222 to network 108 (e.g., such as a LAN, WLAN, PTSN, and/or various other wired or wireless networks, including telecommunications, mobile, and cellular phone networks) may perform instruction sequences to practice the present disclosure in coordination with one another. Computing system 200 may transmit and receive messages, data and one or more data packets, information and instructions, including one or more programs (i.e., application code) through communication link 222 and network interface component 202 and wireless transceiver 220. Received program code may be executed by processing component 206 as received and/or stored in memory component 208.

Computing system 200 may include more or less components than shown in FIG. 2 according to some embodiments. Moreover, components shown in FIG. 2 may be directly coupled to one or more other components in FIG. 2, eliminating a need for system bus 204. Furthermore, components shown in FIG. 2 may be shown as being part of a unitary system 200, but may also be part of a system where the components are separate but coupled and in communication. In general, the components shown in FIG. 2 are shown as examples of components in a computing system 200 capable of performing embodiments disclosed herein. However, computing system 200 may have more or fewer components and still be capable of performing some embodiments disclosed herein.

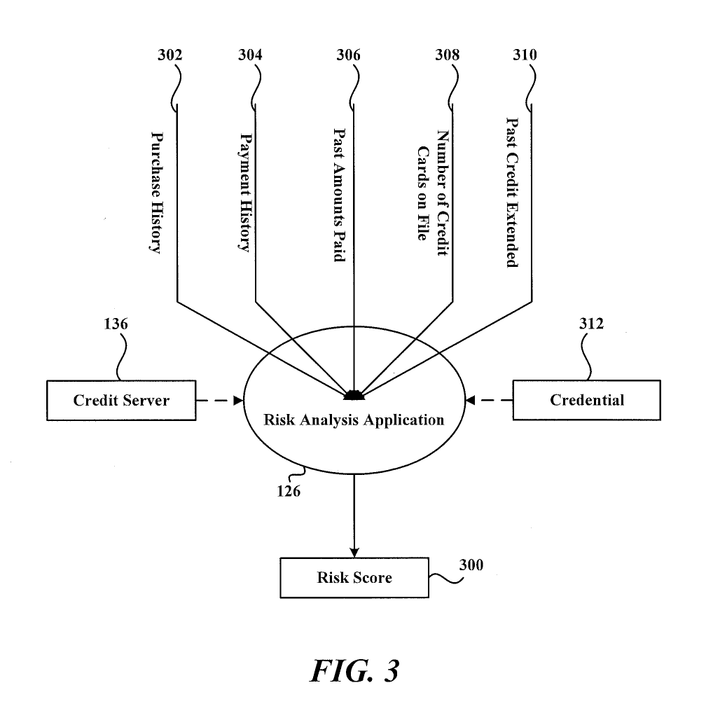

FIG. 3 is a diagram illustrating risk factors used by risk analysis application 126 to determine a risk score 300, consistent with some embodiments. As shown in FIG. 3, risk analysis application 126 receives risk factors about user 110 and uses this information to calculate risk score 300 which may be used to determine if user 110 should be extended credit and how much should be extended. In some embodiments, risk score 300 may be compared to a threshold value and if risk score 300 is greater than the threshold value, then user 110 will be extended credit. In some embodiments, there may be multiple threshold values, and at each threshold that risk score 300 exceeds user 110 may be extended a greater amount of credit.

As shown in FIG. 3, the risk factors about user 110 that is received by risk analysis application 126 includes a purchase history 302 of user 110. In some embodiments, purchase history 302 of user 110 may include all of the items that user 110 has purchased using remote server 106 to process payments for the items. In some embodiments, purchase history 302 may be a subset of all of the items that may be set be an administrator of remote server 106 such that only recent purchases, or purchases made during a predetermined period of time are considered in purchase history 302. Purchase history 302 may also include items purchased and locations where the items were purchased. In some embodiments, if user 110 is requesting credit to purchase an item in a location where user 110 has purchased items before, user 110 may have a lower risk and may be more likely to pay back any credit extended at a location where user 110 is a regular customer or semi-regular customer even if credit is being requested for an establishment at which user 110 has not previously purchased items. Moreover, purchase history 302 may be used to establish patterns of items purchased by user 110 such that user 110 may be more likely to be extended credit, or extended a greater amount of credit, at locations that match purchase patterns of user 110. A payment history 304 may also be considered. In some embodiments, payment history 304 may include all payments made by user 110 using remote server 106, or a subset thereof. Payment history 304 may include payments made for purchases included in purchase history 302 as well as person-to-person payments, payments for gift cards redeemable through remote server 106, and the like. In some embodiments, risk analysis application 126 may weight purchase history 302 and payment history 304 such that more recent purchases and payments are weighed more heavily than older purchases and payments and, thus, contribute more to the calculation of risk score 300.

Risk analysis application 126 may also receive information related to past amounts paid 306 by user 126. In some embodiments, past amounts paid 306 may include the monetary amounts of purchase history 302 and payment history 304, and may be useful in determining an amount of credit to extend to user 110. Risk analysis application 126 may also receive a number of credit cards on file 308. In some embodiments, number of credit cards on file 308 for user 110 may be used in determining risk score 300, as a user with too many or too few credit cards may be someone that is likely to have poor credit. In some embodiments, number of credit cards on file 308 may only refer to a number of credit cards that have been used by remote server 106 to process payments for user 110. Risk analysis application 126 may also receive past credit extended 310 to user 110 by remote server 106. In some embodiments, if remote server 106 has previously extended credit to user 110, information such as whether user 110 paid back the credit extended, how long it took to pay back the credit, whether user 110 made any later payments, and similar information may be useful determining risk score 300.

In some embodiments, risk factors 302-310 may be received or retrieved or accessed from account information 130 of account database 128 and may only be information that remote server 106 has on file in account information 130 related to user 110. Moreover, risk analysis application 126 may be configured to weight risk factors 302-310 so that certain factors may be weighted more heavily than other factors when determining risk score 300.

In some embodiments, risk analysis application 126 may also receive information from credit server 136 for determining risk score 300. In some embodiments, the information received from credit server 136 may include credit score 138, number of credit cards 140, and number of other credit sources 142. When remote server 106 does not have enough information from risk factors 302-310 from account information 130 to adequately determine risk score 300, remote server 106 may query credit server 136 to receive additional information for use in determining credit score 300. Moreover, for amounts of credit that are larger than a predetermined threshold, remote server 106 may query and receive additional information from credit server 136 for use in determining risk score.

In some embodiments, risk analysis application 126 may also use information as to whether or not user 110 has authenticated with remote server 106 using a credential 312 to determine risk score 300. In some embodiments, user 110 may be able to request credit up to a certain amount without having to authenticate with remote server 106 using credential 312 or without being asked to re-authenticate with remote server 106 using credential 312. However, if user 110 is requesting credit that is larger than a threshold amount, risk analysis application 126 may either require that user authenticate with remote server 106 using credential 312 or may use a determination as to whether user 110 has submitted credential 312 in determining risk score 300. In some embodiments, credential 312 may be a low-entropy (or lower security) credential, such as a four-digit personal identification number (PIN), or a high-entropy (or higher security) credential, wherein a high-entropy credential, being more secure, is weighted more heavily than the low-entropy credential.

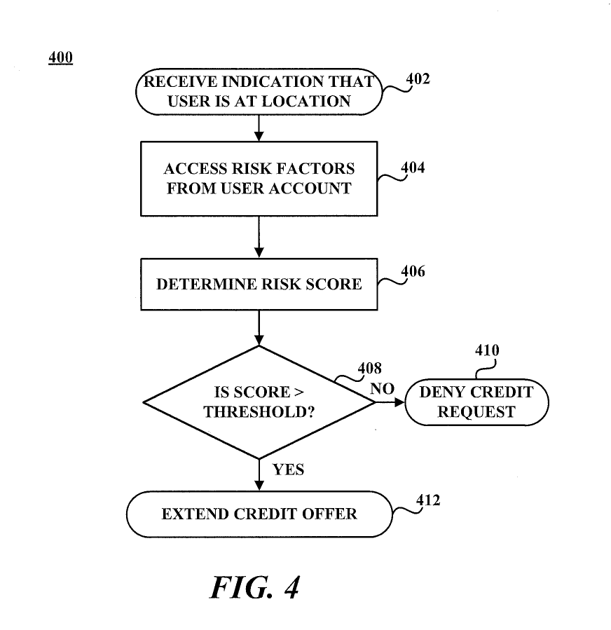

FIG. 4 is a flowchart illustrating a process 400 for evaluating a credit request, consistent with some embodiments. For the purpose of illustration, FIG. 4 will be described with reference to any of FIGS. 1-3. Process 400 shown in FIG. 4 may be embodied in computer-readable instructions for execution by one or more processors in processing component 206 such that the steps of process 400 may be performed by remote server 106. As shown in FIG. 4, process 400 may being when remote server 106 receives an indication that user 110 is at a location (402). The indication may be a check in or check in request, or may be a request for credit at the location. In some embodiments, the indication, whether it is a check in or a request for credit may include an amount of credit requested. Moreover, the received indication may be initiated by user 110 using user device 102, for example, using payment application 114. The received indication may also be initiated by merchant server 104 on behalf of user 110. For example, user 110 may be attempting to purchase an item from merchant server 104 or using a POS in communication with merchant server 104 to purchase an item, and may be provided with an option to obtain credit and pay later which, when selected, initiates a credit request that is sent to remote server 106, with remote server 106 being capable of extending credit.

Risk analysis application 126 may then access risk factors from account information 130 of user 110 in account database 128 (404). In some embodiments, the risk factors may include information 302-310 shown in FIG. 3 and described with respect to FIG. 3 above. In some embodiments, the risk factors accessed may also include information from credit server 136. Based on the accessed information, risk analysis application 126 may determine risk score 300 (406). In some embodiments, certain risk factors may be weighted greater than others when determining risk score 300. Moreover, certain risk factors may have portions that are weighted based on location or time. The determined risk score 300 may then be compared to a threshold (408). When determined risk score 300 is not greater than a threshold, remote server 106 may deny the credit request (410). However, when the determined risk score 300 is greater than the threshold, remote server 106 may extend a credit offer (412). In some embodiments, the extended credit offer may be temporary or time limited, and also may be limited to the location. For example, the extended credit offer may have a time limit of about 5 minutes to about 1 hour.

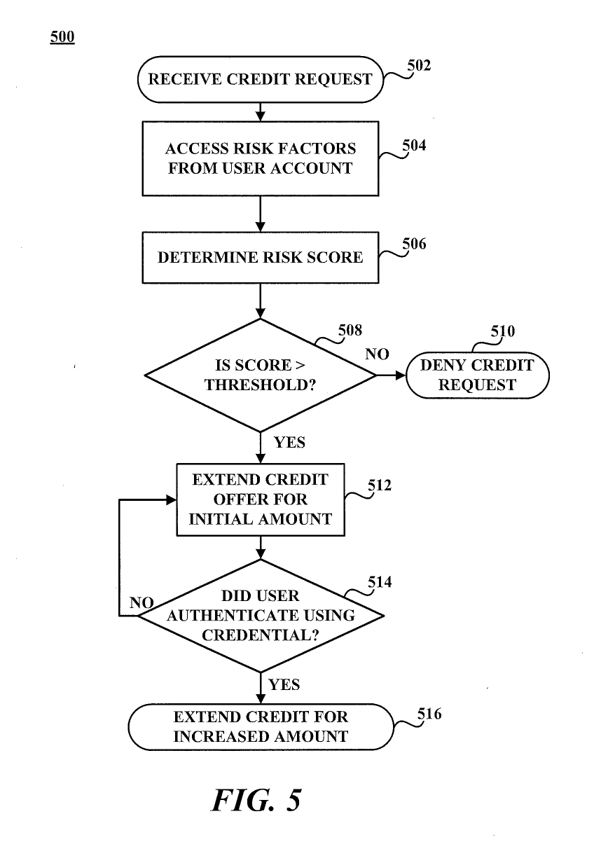

FIG. 5 is a flowchart illustrating a process 500 for evaluating a credit request, consistent with some embodiments. For the purpose of illustration, FIG. 5 will be described with reference to any of FIGS. 1-3. Process 500 shown in FIG. 5 may be embodied in computer-readable instructions for execution by one or more processors in processing component 206 such that the steps of process 500 may be performed by remote server 106. As shown in FIG. 5, process 500 may being when remote server 106 receives a credit request from user 110 (502). In some embodiments, the received credit request may include an amount of credit requested. Moreover, the received credit request may be initiated by user 110 using user device 102, for example, using payment application 114, and may be part of a check in at a merchant location. The received credit request may also be initiated by merchant server 104 on behalf of user 110. For example, user 110 may be attempting to purchase an item from merchant server 104 or using a POS in communication with merchant server 104 to purchase an item, and may be provided with an option to obtain credit and pay later which, when selected, initiates a credit request that is sent to remote server 106, with remote server 106 being capable of extending credit.

Risk analysis application 126 may then access risk factors from account information 130 of user 110 in account database 128 (504). In some embodiments, the risk factors may include information 302-310 shown in FIG. 3 and described with respect to FIG. 3 above. In some embodiments, the risk factors accessed may also include information from credit server 136. Based on the accessed information, risk analysis application 126 may determine risk score 300 (506). In some embodiments, certain risk factors may be weighted greater than others when determining risk score 300. Moreover, certain risk factors may have portions that are weighted based on location or time. The determined risk score 300 may then be compared to a threshold (508). When determined risk score 300 is not greater than a threshold, remote server 106 may deny the credit request (510).

However, when the determined risk score 300 is greater than the threshold, remote server 106 may extend a credit offer for an initial amount (512). In some embodiments, the initial amount may be an amount that corresponds to the amount requested in the received credit request. In some embodiments, the initial amount may be an amount that corresponds to determined score 300. For example, score 300 may be greater than an initial threshold that is sufficient to extend a predetermined amount to user 110, whereas when score 300 is greater than a larger threshold, additional credit may be extended to user 110. Risk analysis application 126 may further determine when user 110 authenticates with remote server 106 using a credential 312 (514) such that when user authenticates with remote server 106 using credential 312, remote server 106 may extend credit to user 110 for an increased amount (516). In some embodiments, determining when user 110 authenticates with remote server 106 may include determining when user 110 authenticates with remote server 106 using a more secure credential, or a credential having higher entropy. When user 110 does not authenticate with remote server 106 using credential 312, user may be extended a credit offer for the initial amount (512). In some embodiments, the extended credit offer may be temporary or time limited, and also may be limited to the location.

Software, in accordance with the present disclosure, such as program code and/or data, may be stored on one or more machine-readable mediums, including non-transitory machine-readable medium. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

Consequently, embodiments as described herein may allow credit to be extended to a user based on a risk score determined from risk factors associated with the user. Moreover, embodiments as described herein may also allow a user to obtain time limited and location limited credit to allow the user to use credit to purchase one or more items at a locations. The examples provided above are exemplary only and are not intended to be limiting. One skilled in the art may readily devise other systems consistent with the disclosed embodiments which are intended to be within the scope of this disclosure. As such, the application is limited only by the following claims.

What is claimed is:

1. A system for determining a risk in extending credit to a user, comprising:
one or more processors configured to:
receive an indication that a user is at a location;
receive risk factors from account information of the user, the risk factors including at least a purchase history, a payment history, past amounts paid, a first number of credit cards associated with the user, and past credit extended to the user; and
determine a risk score based on the received risk factors;
determine when the risk score is greater than a threshold; and
extend credit to the user when the risk score is greater than the threshold; and
a memory coupled to the one or more processors and configured to store the account information of the user including the risk factors.

2. The system of claim 1, further comprising:
a network interface component configured to receive credit information associated with the user, the credit information including at least one of a credit score, a second number of credit cards associated with the user, and a number of other sources of credit extended to the user.

3. The system of claim 2, wherein the one or more processors are further configured to determine the risk score based on the received risk factors and the received credit information.

4. The system of claim 1, wherein the one or more processors are further configured to determine an amount of credit to extend to the user when the risk score is greater than the threshold.

5. The system of claim 4, wherein the wherein the one or more processors are configured to determine an amount of credit to extend to the user based on the risk score.

6. The system of claim 5, wherein the threshold comprises a plurality of increasing threshold levels, wherein each threshold level corresponds to an increasing amount of credit to extend to the user.

7. The system of claim 4, wherein the one or more processors are configured to determine the amount of credit to extend to the user based on determining when the user authenticates with the system using a credential.

8. The system of claim 7, wherein the one or more processors are configured to extend a larger amount of credit to the user when the user authenticates with the system using a credential than when the user does not authenticate with the system.

9. The system of claim 7, wherein the one or more processors are configured to extend a larger amount of credit to the user when the user authenticates with the system with a more secure credential than when the user authenticates with the system with a less secure credential.

10. The system of claim 1, wherein the one or more processors are configured to determine to receive the indication that the user is at the location by receiving a request to check in the user at the location.

11. The system of claim 1, wherein extended credit is temporary.

12. A computer-readable medium including instructions that, when executed by one or more processors, cause the one or more processors to perform a method for extending credit to a user, the method comprising:
receiving an indication that a user is at a location;
receiving risk factors from account information of the user, the risk factors including at least a purchase history, a payment history, past amounts paid, a first number of credit cards associated with the user, and past credit extended to the user;
determining a risk score based on the received risk factors;
determining when the risk score is greater than a threshold; and
extending credit to the user when the risk score is greater than the threshold.

13. The computer-readable medium of claim 12, further comprising:
receiving credit information associated with the user, the credit information including at least one of a credit score, a second number of credit cards associated with the user, and a number of other sources of credit extended to the user.

14. The computer-readable medium of claim 13, wherein determining the risk score comprises determining the risk score based on the received risk factors and the received credit information.

15. The computer-readable medium of claim 12, further comprising determining an amount of credit to extend to the user when the risk score is greater than the threshold.

16. The computer-readable medium of claim 15, wherein determining an amount of credit to extent to the user comprises determining an amount of credit to extend to the user based on the risk score.

17. The computer-readable medium of claim 16, wherein the threshold comprises a plurality of increasing threshold levels, wherein each threshold level corresponds to an increasing amount of credit to extent to the user.

18. The computer-readable medium of claim 15, wherein determining the amount of credit to extend to the user comprises determining when the user authenticates with the system using a credential.

20. The computer-readable medium of claim 18, wherein determining the amount of credit to extend to the user comprises extending a larger amount of credit to the user when the user authenticates with the system using a credential than when the user does not authenticate with the system.

21. The computer-readable medium of claim 18, wherein determining the amount of credit to extend to the user comprises extending a larger amount of credit to the user when the user authenticates with the system with a more secure credential than when the user authenticates with the system with a less secure credential.

22. The computer-readable medium of claim 12, wherein receiving an indication that the user is at the location comprises receiving a check in request from the user.

23. The computer-readable medium of claim 12, wherein extending credit to the user comprises extending temporary credit to the user.

24. A method for extending credit to a user, comprising:
receiving, by one or more processors of a payment processing server, a request to check the user into a location;
receiving, by the one or more processors, risk factors from account information of the user associated with the payment processing server stored in a memory of the payment processing server, the risk factors including at least a purchase history, a payment history, past amounts paid, a first number of credit cards associated with the user, and past credit extended to the user;
determining, by the one or more processors, a risk score based on the received risk factors;
determining, by the one or more processors, when the risk score is greater than a threshold;
extending, by the one or more processors, an initial amount of credit to the user when the risk score is greater than the threshold, the credit being specific to the location and having an expiration time;
determining, by the one or more processors, when the user authenticates with the payment processing server; and
extending, by the one or more processors, a second amount of credit to the user that is larger than the initial amount of credit when the user authenticates with the payment processing server.

25. The method of claim 24, wherein determining when the user authenticates with the payment processing server comprises determining, by the one or more processors, when the user authenticates with the payment processing server using a secure credential.
